(19) United States
(12) Patent Application Publication
(10) Pub. No.: US 2026/0309149 A1
(43) Pub. Date: Oct. 8, 2026

(54) Improved Positive-Displacement Rotary Hydraulic Machine

(71) Applicant: Stem Numerical Engineering S.R.L., Modena (IT)

(72) Inventor: Mario Antonio Morselli, Modena (IT)

(73) Assignee: Stem Numerical Engineering S.R.L., Modena (IT)

(21) Appl. No.: 19/480,901

(22) PCT Filed: May 3, 2024
(86) PCT No.: PCT/IB2024/054292

§ 371 Date: Nov. 3, 2025

(30) Foreign Application Priority Data
May 5, 2023 (IT) 102023000008985

(51) Int. Cl. F04C 2/08

(52) U.S. Cl. CPC F04C 2/084; F04C 2240/30

(57) ABSTRACT

A rotary positive-displacement machine including two gear wheels, which mesh, and that include a driving gear wheel and a driven gear wheel, respectively, enclosed in a pump housing having a delivery opening and an intake opening for a fluid is provided. The two gear wheels comprise a plurality of teeth, which mesh and the two gear wheels include respective shafts each supported by bushings housed inside said pump housing. The material of which the bushings are made has a thermal expansion coefficient equal to the thermal expansion coefficient of the material of which said two gear wheels are made, or differing by less than a factor of +/−15%.

### CROSS-REFERENCE TO RELATED APPLICATIONS

This application is a 371 National Stage entry of PCT/IB2024/054292, filed on May 3, 2024, which claims the benefit of foreign priority to IT 102023000008985, filed on May 5, 2023, in the Italian Republic, the entire contents of which are incorporated by reference herein.

### TECHNICAL FIELD

The present disclosure relates to an improved rotary positive-displacement hydraulic machine. The term rotary positive-displacement hydraulic machine refers to both hydraulic pumps and hydraulic motors. The present disclosure relates in particular to a positive-displacement pump with helical rotors, comprising a pair of rotors or gear wheels, driving and driven, respectively, enclosed in a casing with a delivery opening and an intake opening for a fluid, wherein the gear wheels comprise a plurality of teeth meshing without encapsulation and simultaneously defining sets of helical teeth with a face overlap comprised between 0.75 and 1.1.

### BACKGROUND

As is well known, there are currently rotary positive-displacement pumps with helical rotors with face overlap close to unity, such as those described in patent EP1132618B1 or patent U.S. Pat. No. 6,887,055B2. Such helical pumps with face overlap close to unity are characterised in that the meshed teeth extend helically along the height of each gear with axial pitch between two successive teeth equal, or close, to the height of the gear in the direction of the axis of rotation. With this configuration, the transverse profile of a tooth at one end face of the gears is essentially aligned, in a direction parallel to the axis of rotation of the gears, with the transverse profile of an adjacent tooth at the other end face of the respective gear. In other words, the head of a tooth of one gear is combined with the bottom of a tooth of the other gear and there is a double contact, both between the active flanks of the two meshing teeth of the driving and driven gear respectively, and between their respective inactive flanks.

The term “active” refers to the portion of the tooth flank that transmits torque, while the term “inactive” refers to the portion of the tooth flank that does not transmit torque.

With regard to the “contact” that occurs between the “active” flank portions, a distinction should be made between the contact of the ideal meshing geometry and the actual contact that occurs during pump operation. In fact, even a small amount of clearance is necessary for meshing, so that one part of the flank, the driving part, will be in contact, while both the driven flank and the area between the bottom of the tooth and the tooth head will have a minimum of clearance. In this type of helical pumps, the meshing contact extends continuously from one end face to the other, passing from the active flank to the inactive flank via the bottom zone between the heads of two teeth. Consequently, in the part of the toothing where meshing takes place on the inactive flank, there is still mechanical clearance.

In this way, there is continuous meshing between the teeth of the two gears, at least under ideal conditions, i.e. no encapsulation conditions (i.e. fluid entrapment) occur.

These helical rotor positive-displacement pumps with face overlap close to unity and continuous contact have particular advantages over other types of positive-displacement pumps, first and foremost the fact that during pump operation there are no discontinuities in the variation of volume that causes the transport of fluid from the intake to the delivery, with the result that fluctuations in fluid flow rate, unless there are manufacturing tolerances and imperfections in the wheels, are zero or at least drastically reduced. These pumps are therefore able to guarantee a considerable reduction in the so-called “delivery ripple” and thus reduce “pressure ripple” and the resulting noise.

On the other hand, such helical rotor positive-displacement pumps with face overlap close to unity and continuous contact of a known type are not without their drawbacks, among which is the fact that, when used for medium-high pressures, e.g. 80-100 to 250 bar and above, they have a rather low positive-displacement efficiency already at operating temperatures of 40°-50°, an efficiency that drops dramatically with a further increase in operating temperature. Another drawback of these well-known pump types is that they are particularly delicate, and put a lot of stress on the side shims, thus limiting the maximum pressure that can be reliably reached, and requiring well-filtered, particle-free hydraulic fluids.

In addition, the helical profile with a rounded tooth head and no sharp edges makes the run-in phase of the pump very delicate, a phase in which the tooth head abrades the rotor containment casing (i.e., the pump housing), with slight removal of the material of which this casing is made. This material must therefore have good mechanical performance to withstand the internal pressure without breaking or plastically deforming, but at the same time it must be suitably yielding to allow the pump to run in properly, thus avoiding undesirable fluid leakage between the tooth head and the housing itself.

In this run-in phase, especially if the pump casing material has high strength characteristics, the internal surface of the pump casing will have a poor geometry and unwanted abrasion will also occur on the tooth head, a phenomenon that leads to increased clearance between the head and tooth bottom, resulting in increased positive-displacement leakage losses. A further drawback of these well-known pumps is that they do not reliably achieve the operating pressures that can be reached with conventional, compensated external gear pumps. “Compensated” refers to pumps in which a moving component is brought, by the fluid at the pump discharge pressure, to be adherent to the side planes of the toothing, with areas of action of the pressure difference actually being “compensated”, so that the contact force between the moving component and the side planes of the toothing is for the most part balanced—compensated—while a residual part brings the moving component to be adherent.

All these limitations make helical rotor pumps, with continuous contact, with face overlap close to unity, of the known type difficult to use, for example, in the electrical sector and in particular in the mobility sector, both electric and traditional, which is one of the currently leading technological sectors.

### SUMMARY

In view of the above, the task of the present disclosure is to provide an improved rotary positive-displacement hydraulic machine that exceeds the limits of known technology by being more efficient, even at increasing operating temperatures.

Within the scope of this task, it is the aim of the present disclosure to provide an improved rotary positive-displacement hydraulic machine that can also operate at high pressures, significantly higher than those achievable with current technology, continuously, and with good reliability, comparable to that of hydraulic machines with internal gears.

Another purpose of the present disclosure is to provide an improved rotary positive-displacement hydraulic machine that is efficient even when operating at low speeds in the range of 150-200 rpm.

A further aim of the disclosure is to provide an improved rotary positive-displacement hydraulic machine that makes the run-in between the tooth head and housing easy and practical, without sacrificing the possibility of the pump operating at high pressures.

A further object of the disclosure consists of providing an improved rotary positive-displacement hydraulic machine that is capable of providing the broadest guarantees of reliability and safety when used.

Yet another aim of the disclosure is to provide an improved rotary positive-displacement hydraulic machine that is easy to manufacture and technically competitive, in terms of robustness and efficiency, when compared to the prior art.

The task disclosed above, and also the objects mentioned and others which are more apparent below, are achieved by an improved rotary positive-displacement hydraulic machine according to claim 1 and according to claim 16.

Other features are provided in the dependent claims.

### BRIEF DESCRIPTION OF THE DRAWINGS

Further characteristics and advantages of the present disclosure will become more apparent from the exemplary but non-limiting description of a preferred aspect of the present disclosure illustrated with the aid of the attached drawings in which:

FIG. 1 is a view of an aspect of an improved rotary positive-displacement pump from the side opposite the motion intake shaft, according to the disclosure;

FIG. 2 is a cross-sectional view of the pump shown in FIG. 1;

FIG. 3 schematically represents an example of a bushing in the pump in FIGS. 1 and 2;

FIG. 4 represents a variant of the pump shown in FIG. 2;

FIG. 5 is a cross-sectional view of an improved rotary positive-displacement pump with helical rotors.

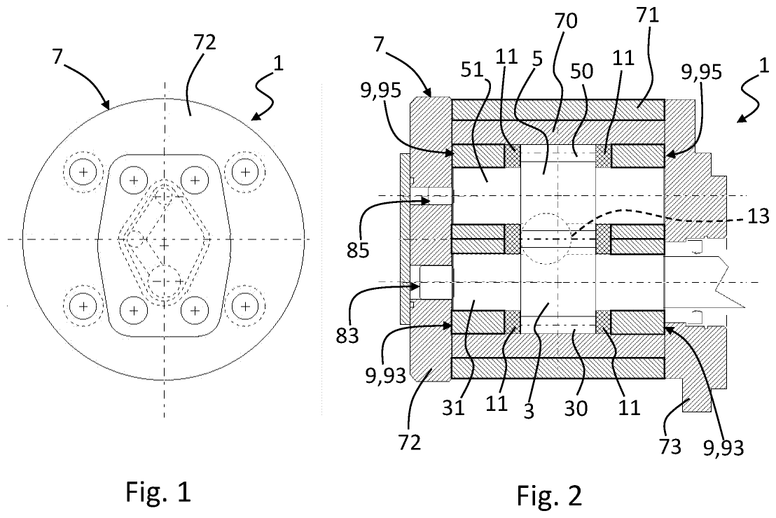

### DETAILED DESCRIPTION

With particular reference to the figures, a rotary positive-displacement machine is illustrated, and in particular an improved rotary positive-displacement pump with helical rotors, collectively referred to by reference number 1. Such a pump 1 comprises a pair of meshing gear wheels 3, 5, a driving gear 3 and a driven gear 5 respectively, enclosed in a pump housing 7 with a delivery port and an intake port for a fluid. The two gear wheels 3, 5 comprise a plurality of teeth 30, 50. In particular, these teeth 30, 50 are meshing teeth without encapsulation and simultaneously defining helical teeth with face overlap comprised between 0.75 and 1.1. The two gear wheels 3, 5 comprise respective shafts 31, 51 supported by bushings 9 housed inside the pump housing 7.

According to the disclosure, the material of which the bushings 9 are made has a thermal expansion coefficient equal to the thermal expansion coefficient of the material of which the two gear wheels 3, 5 are made, less than a factor of +/−15%. Preferably, the thermal expansion coefficient of the bushing material 9 is equal to the thermal expansion coefficient of the material of which the two gear wheels are made 3, 5 less than a factor of +/−5%, and more preferably +/−1%.

The bushings 9 can be made of steel or cast iron. This is particularly the case if the gear wheels 3, 5 (and the respective shafts 31, 51) are made of steel. For example, the bushings 9 can be made of high machinability steel (or steel for high-speed machining).

The bushings 9 may be manufactured by sintering steel powder, or compounds containing a sufficient quantity of graphite to produce a material with a thermal expansion coefficient equal, less than a factor of +/−15% (or preferably +/−5% or more preferably +/−1%), to the thermal expansion coefficient of the material of which the two gear wheels 3, 5 are made.

The bushings 9 can also be of the “floating” type such as those currently used in balanced pumps. In particular, floating bushings can be balanced by means of a sealing element placed, under pressure, on the opposite side of the gear wheels. This element contributes to delimiting an area slightly larger than that which is needed to balance the pressure force generated on the toothing side and thus allows a resultant pressure on the opposite side to the gear wheel side comparable to the resultant pressure of the pressure zone on the gear wheel side. In this way, the floating bushings, which have minimal mechanical clearance, can slide inside the pump housing and are made to adhere to the face of the toothing of the gear wheels, ensuring the sealing of the fluid with moderate contact loads between the bushings themselves and the face of the toothing.

Alternatively, the bushings can be made of cast iron.

The gear wheels 3, 5 can be made of steel, preferably hardened steel, e.g. cemented and tempered steel (known as “cmt-tmp steel”), or nitriding steel (known as “Nt steel”), or even fully hardened steel.

Thus, as the operating temperature increases, there is no significant differential increase in centre distance between the centre axis of the bushings 9 and the centre axis of the gear wheels 3, 5. There is also no significant increase in the distance between the teeth 30, 50 of the gear wheels 3, 5 and the inner surface of the pump housing 7, nor is there a significant increase in the distance between the inactive flank portions of the gear wheels 3, 5.

The present disclosure thus solves the problem of positive-displacement efficiency losses that penalize pumps of the known type, efficiency losses that are largely due to sealing losses between the head and bottom of the teeth and between the inactive parts of the tooth flanks of the gear wheels, where the necessary operating clearance, albeit of a limited magnitude, opens up gaps through which the pumped fluid passes. In fact, these losses can be controlled by suitably reducing this operating clearance, but are greatly exacerbated as the temperature rises, due to differential thermal expansion between the components of the pump itself (e.g. between the toothed wheels and the support bushings, for example). In fact, if the increase in temperature causes a thermal expansion of the bushings that is significantly greater than that of the gear wheels, there is an increase in the operating centre distance of the gear wheels that is greater than the increase resulting from the thermal expansion of the gear wheels alone, and thus the size of the passage gap increases accordingly. Similarly, the head of the teeth moves away from the pump housing as the temperature rises. It is also well known that fluid passage, in positive-displacement terms, depends on the gap width with a cubic law, and therefore the impact on positive-displacement efficiency loss due to differential thermal expansion is very high and strongly undesirable.

Currently, the material used for the construction of bushings in continuous-contact helical pumps of the known type is aluminium, which has a thermal expansion coefficient approximately double that of the steel from of gear wheels are generally made. These pumps are constructed and assembled at room temperature, and it is only during their operation, which takes place at operating temperatures between 40° C. and 80° C., that the severity of the problem resulting from thermal expansion that this disclosure aims to overcome becomes apparent.

Preferably, the bushings 9 and the two gear wheels 3, 5 are made of the same material. Preferably in this case the bushings 9 and the two gear wheels 3, 5 are made of steel.

Preferably, the inner cylindrical surface of the bushings 9 is treated in such a way as to ensure self-lubricating behaviour, or, in any case, has tribological properties suitable for the operation of a hydrodynamic bearing. The inner cylindrical surface of the bushings 9 may comprise an insert of self-lubricating material, such as Teflon, or bronze, or brass. Again, the bushings 9 can be defined by an assembly of a laterally flattened cylindrical body (or two cylindrical bodies joined in a “figure-of-eight”) within which a multilayer bushing is inserted, comprising three layers of steel, sintered bronze and Teflon respectively, as well as small amounts of other materials.

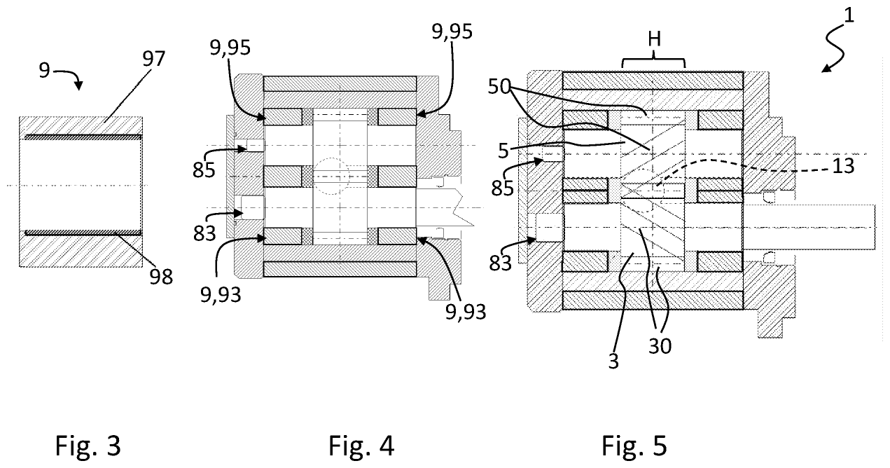

An example of such an assembly is illustrated schematically in FIG. 3. This assembly comprises an outer annular element 97, also known as the “bushing ring”, and an inner annular element 98, which forms the bushing 9. This inner annular element 98 is composed of a multilayer of steel, sintered bronze and Teflon.

The bushings 9 may comprise a first pair of bushings 93 adapted to support the shaft 31 of the driving gear wheel 3 from two opposite sides thereof, and a second pair of bushings 95 adapted to support the shaft 51 of the driven gear wheel 5 from two opposite sides thereof.

The bushings 9 can all be separated from each other, as illustrated in FIG. 2, or joined two by two, as illustrated in FIG. 4.

In particular, with reference to this second case, at least one first bushing of the first pair of bushings 93 is joined to, or made in one piece with, a first bushing of the second pair of bushings 95. Similarly, a second bushing of the first pair of bushings 93 can be joined to, or made in one piece with, a second bushing of the second pair of bushings 95.

In essence, therefore, the bushings 9 can present a “figure of eight” configuration, in which they are completed two by two. It is also possible for the bushings 9 on one side to be joined in a “figure of eight” configuration and on the opposite side to be separated from each other.

The pump housing 7 comprises, as illustrated in particular in FIG. 2, a flange 73 and a cover 72, which are adapted to close the axial ends of the pump housing 7 itself, respectively on the side where the motion intake shaft 31 is located and on the opposite side.

According to a further aspect, at least some of the bushings can be integrated into the cover 72 and/or flange 73 of the pump 1 itself, wherein said cover 72 and/or said flange 73 are also made of the materials described above with reference to the bushings 9, such as steel or cast iron. In other words, two support holes can be formed in the cover 72 and/or flange 73, at a suitable centre distance, to support the shafts 31, 51 of the gear wheels 3, 5, adapted to perform the function of the bushings 9 described above. These holes preferably have an inner cylindrical surface treated in such a way as to guarantee self-lubricating behaviour, or, in any case, have tribological properties suitable for the operation of a hydrodynamic bearing, or else comprise an insert of self-lubricating material, such as Teflon, or bronze, or brass, or even a solution such as the multilayer bushings described above.

Preferably, the pump 1 comprises one or two floating shim plates 11 arranged, along an axial direction, between each of the gear wheels 3, 5 and each of the bushings 9.

Advantageously, while the bushings 9 perform their support function in an almost radial direction, the floating shim plates 11 are free to move axially because they are not subject to radial loads, and consequently are not subject to friction forces in the axial direction.

Preferably, the floating shim plates 11 are made of materials with high tribological properties. For example, they can be made of different types of bronze, such as manganese bronze or tin bronze, or tin and lead bronze, or even ternary Cu—Sn—Ni or Cu—Ni—Su bronzes, or beryllium bronze, or brass, or even aluminium alloys, such as aluminium-tin alloys.

The material of which the floating shim plates 11 are made may have a higher thermal expansion coefficient than the material of the bushings 9 and gear wheels 3, 5. However, the thermal expansion of the plates 11 does not present any particular critical issues as it does not affect either the spacing of the bushings 9 and gear wheels 3, 5, or the distance between the tooth heads 30, 50 and the pump housing 7. In addition, there is sufficient clearance between the holes of the shim plates 11 and the shafts 31, 51 of the gear wheels 3, 5 to prevent them from contacting each other.

Moreover, since the shim plates 11 are separated from the bushings 9 by a small gap, they tend not to absorb the heat from the heat dissipation that occurs at the interface between the shafts 31, 51 of the gear wheels 3, 5 and the bushings 9 themselves. The balance of pressure forces of the floating shim plates 11 is similar to that described above with reference to the floating bushings.

The shim plates 11 can have a “figure-of-eight” configuration.

As an alternative to the presence of the floating shim plates 11 separate and distinct from the bushings 9, it is possible to provide that the planar faces of the bushings 9 intended to face, in the axial direction, the toothed wheels 3, 5 may comprise a coating made of anti-friction material, e.g. applied by plasma technology, so as to obtain a floating bushing solution on at least one side thereof. In fact, it is possible to obtain a configuration in which only the bushings or shim plates are floating on one side, with the shims being closed in a pack against the toothing on the other side.

In any case, the separation of the functions of bushings 9 and shim plates 11 (i.e., radial load support function on the bushings 9 and axial load support function on the shim plates 11) also facilitates the choice of materials for these components, whereby on the one hand the choice of thermal expansion coefficient is favoured, in the case of the bushings 9, while on the other hand the tribological properties are favoured, in the case of the shim plates 11.

Preferably, the pump housing 7 comprises a radially internal portion 70 adapted to face the teeth 30, 50 of the gear wheels 3, 5. This radially internal portion 70 of the pump housing 7 is made of a material with a hardness of less than 160 HB (measured according to the Brinell scale), preferably less than 140 HB, more preferably less than 120 HB. In a preferred aspect of the disclosure, this material has a hardness comprised between 50 and 95 HB.

Preferably, the radially internal 70 portion of the pump housing 7 is made of a material with a hardness comprised between 50 and 95 HB, as this hardness value represents the best compromise between mechanical strength and run-in possibility of the pump 1.

Preferably the radially internal 70 portion of the pump housing 7 is made of aluminium or aluminium alloy.

In particular, the use of excessively hard materials for the portion 70 of the pump housing 7 in contact with the teeth 30, 50 of the gear wheels 3, 5, such as cast iron, would not allow the pump 1 to complete the run-in step in the proper manner, due to the shape of the teeth typical of continuous contact helical pumps. Similarly, some high-performance aluminium alloys can make the run-in of the pump 1 more difficult.

Preferably, the pump housing 7 comprises, in addition to the radially internal portion 70, also a radially external portion 71, made of a material having a thermal expansion coefficient equal to, less than a factor of +/−15% (or preferably +/−5% or even +/−1%), the thermal expansion coefficient of the material of which the two gear wheels 3, 5 are made.

Preferably, the radially external portion 71 of the pump housing 7 is made of steel, e.g. high machinability steel (or high-speed machining steel). This portion 71 can also be made of steels for mechanical constructions, such as those used for drawing pipes, for example Fe360 (UNI7945), or Fe360 (UNI6403), or Fe35-2 (UNI 663), or Fe410 (UNI7945), or Fe45-2 (UNI663), or Fe490 (UNI7945), or Fe510 (UNI 6403).

Alternatively, the radially external portion 71 of the pump housing 7 can be made of cast iron.

In essence, the pump housing 7 is preferably formed by an inner tubular structure, which defines the radially internal portion 70, and an outer tubular structure, which defines the radially external portion 71.

Thus, the internal portion 70 made of aluminium is encircled by an external element 71 made of steel or cast iron. Consequently, the pump housing 7 has low hardness of its internal aluminium part 70, compatible with the run-in step, but high mechanical resistance to internal pressure, and compensation of differential thermal expansion, conferred by the external steel part 71.

In other words, the aluminium internal housing 70 allows for a run-in with surface excavation by the teeth head 30, 50 of the gear wheels 3, 5 while the steel external jacket 71 opposes, at increasing operating temperatures, the thermal expansion of the aluminium, limiting and containing it. As the operating temperature increases, the external jacket 71 works in tension while the internal housing 70 works in compression.

Preferably, a material having a Young's modulus of elasticity greater than the Young's modulus of the material of which the internal housing 70 is made, preferably at least twice as high, may be selected as the material for the external jacket 71. Thus, tensile stresses will cause elastic deformation in inverse proportion to the respective elastic moduli of the materials of the external jacket 71 and the internal housing 70. Consequently, the external jacket 71 will undergo less expansion than the internal housing 70, so that the contraction due to compressive stresses can effectively compensate for the thermal expansion of the materials. For example, if the external jacket 71 is made of steel, having a Young's modulus of approximately 200,000-205,000 MPa, while the internal housing 70 is made of aluminium, having a Young's modulus of approximately 65,000-70,000 MPa, there will be good compensation of thermal expansion even in the case of pumps 1 in which the cross-sectional thickness in the radial direction of the external jacket 71 and the internal housing 70 is almost comparable, as is the case with the aspect illustrated in the accompanying figures.

This makes it possible to limit or eliminate the tensile stresses on the aluminium, allowing higher operating pressures with the same permissible material stresses and using mechanically less performing materials, as well as having the advantage of severely limiting deformations of the housing induced by the internal pressure, deformations that are detrimental to the efficiency of the pump.

In addition, in this way, a low-hardness aluminium alloy can be used for the internal portion 70, which is optimal for the run-in step, because mechanical strength is guaranteed by the ring element 71.

The thermal expansion of the various components of the pump 1 is thus essentially compensated for, thus keeping the clearance between the components practically constant as the temperature of the fluid to be pumped varies.

In the event that the pump housing 7 also includes such an external steel ring 71, the bushings 9 can be made either separate from each other or in the “figure-of-eight” configuration described above.

Alternatively, the pump housing 7 may have a tubular structure made of a single material with a hardness of less than 160 HB, preferably less than 130 HB, and preferably comprised between 75 and 130 HB, and more preferably comprised between 80 and 110 HB. For example, the pump housing 7 can be made entirely of aluminium.

In this case, however, it is preferable that the bushings 9 are either made joined together in pairs, i.e. in the “figure-of-eight” configuration described above, or made integral with the cover 72 and/or flange 73, of steel or cast iron, as described above. Alternatively, if the bushings 9 are made separate from each other, it is preferable to provide external mechanical means, such as screws, to hold them in place next to each other.

Preferably, the improved helical rotor positive-displacement pump is configured to operate at operating pressures significantly higher than those achievable with current technology, e.g. at pressures that characterize internally compensated gear pumps, such as so-called “crescent” pumps. Preferably, the pump according to the disclosure can operate at pressures greater than 250 bar or more preferably greater than 300 bar.

Preferably the gear wheels 3, 5 each comprise a number of teeth 30, 50 equal to seven or eight.

Preferably there are eight teeth 30, 50. Thus, by selecting a face overlap of less than 1 and a number of teeth equal to eight, it is possible, compared to a seven-tooth solution, to reduce the helix angle and consequently reduce the load on the bushings 9. This also leads to improved sealing and thus better efficiency.

Preferably, the intake port 13 of the pump 1 is offset axially from the centreline of the toothing, so that the load on the bushings 9 can be further reduced.

FIG. 5 shows an improved rotary positive-displacement pump with helical rotors, in which the gear wheels 3, 5 comprise a plurality of helical teeth 30, 50. The gear wheels 3, 5 have a predefined height H in the axial direction.

Preferably, the intake port 13 of the pump 1 is asymmetrically positioned along the axial direction with respect to the height H of the gear wheels 3, 5, and centrally positioned between the two gear wheels 3, 5 with respect to a direction orthogonal to the axial direction.

For example, instead of being positioned symmetrically at the centre of the height H of the gear wheels 3, 5, the intake port 13 is positioned towards one of the two axial ends of the height H of the gear wheels 3, 5.

The positioning the intake port 13 asymmetrically to the height H of the gear wheels 3, 5 implies at least three advantages:
for the same stress on the bushings 9 and shafts 31, 51 the maximum operating pressure can be increased by approximately 10%;
friction losses on the bushings 9 drop by approximately 10%
bending stresses cause approximately 10% less stress and deformation.

The present disclosure also relates to a double-contact rotary positive-displacement pump comprising a pair of meshing gear wheels 3, 5, respectively a driving gear 3 and a driven gear 5, enclosed in a pump housing 7 having a delivery port and an intake port of a fluid, wherein said two gear wheels 3, 5 comprise a plurality of meshing teeth 30, 50, and wherein said two gear wheels 3, 5 comprise respective shafts 31, 51 supported by bushings 9 housed inside said pump housing 7. According to the disclosure, as in the case of rotary positive-displacement pumps with helical rotors, the material of which the bushings 9 are made has a thermal expansion coefficient equal to the thermal expansion coefficient of the material of which the two gear wheels 3, 5 are made, less than a factor of +/−15%.

In addition, all the technical features described above with reference to the improved rotary positive-displacement pump with helical rotors, and in particular with reference to the bushings 9, the floating shim plates 11, and the intake port 13 also refer to the double-contact rotary positive-displacement pump solution.

Unlike continuous-contact rotary positive-displacement pumps with helical rotors, double-contact rotary positive-displacement pumps can have both straight and helical teeth, but have mechanical clearance between the teeth in the range of thousandths of a millimetre, rather than in the range of tenths or hundredths of a millimetre. Differential thermal expansion is also very critical for this type of pump, as it can lead to increases in the centre distance between the gear wheels, resulting in an increase in clearance between the teeth, an increase which for this type of pump has a strong impact on its proper functioning.

Advantageously, the pump 1 comprises balancing means having surfaces whose area is configured so that the resultant of the forces acting on the components of the pump 1 along the axial direction is adapted to keep the floating shim plates 11 present on the side opposite the motion input shaft 31 and the gear wheels 3, 5 pressed against the floating shim plates 11 present on the side of the motion input shaft 31, and consequently to keep the floating shim plates 11 present on the side of the input shaft 31 pressed against the bushings 9 on the side of the motion input shaft 31. In this way, the floating shim plates 11 on the motion input shaft 31 side will in fact be non-floating. With reference to the figures, this phenomenon occurs because the set of balancing forces acting from the left towards the right exceed the internal hydraulic and mechanical forces acting on the toothed wheels 3, 5 and acting on the shim plates 11 on the left, so that the shim plates 11 on the left and the toothed wheels 3, 5 themselves are pressed against the shim plates 11 on the right, which will be, in practice, non-floating and pressed against the bushings 9 on the right. The forces at stake on the shim plates 11 result from a difference in the extensions of the areas exposed to the delivery pressure, the mechanical axial forces result from the meshing forces of the teeth 30, 50, the hydraulic forces on the gear wheels 3, 5 result from the difference between the extension of the area on the right and the extension of the area on the left exposed to the delivery pressure. The balancing means may comprise, at least, a pair of striker pins 83, 85 housed inside the pump housing 7 so as to strike against the ends of the shafts 31, 51 respectively. Said striker pins 83, 85 comprise a striker surface against the respective ends of the shafts 31, 51 whose area is configured, as mentioned above, so that the resultant of the forces acting in the axial direction keeps the floating shim plates 11 on the side of the input shaft 31 pressed against the bushings 9 on the side of the motion input shaft 31.

The operation of the improved rotary positive-displacement machine is clear and evident from what is described.

The disclosure has been described with reference to a hydraulic pump, but the same considerations also apply in the case of a hydraulic motor.

In practice, it has been found that the improved rotary positive-displacement machine according to the present disclosure fulfils the task as well as the intended purpose as its efficiency is not dependent on operating temperature.

Another advantage of the hydraulic machine, according to the disclosure, is that it can operate efficiently at both high pressures (e.g. 250 bar and higher) and low speeds (e.g. 150-200 rpm).

The rotary positive-displacement machine thus conceived can undergo several modifications and variants all within the scope of the inventive concept.

Furthermore, all the details can be replaced by other technically equivalent elements. In practice, any materials can be used according to requirements, as long as they are compatible with the specific use, the dimensions and the contingent shapes.

1. An improved rotary positive-displacement hydraulic machine comprising two gear wheels, which mesh including a driving gear wheel and a driven gear wheel respectively, enclosed in a pump housing having a delivery opening and an intake opening for a fluid, wherein said two gear wheels include a plurality of teeth, which mesh, wherein said two gear wheels include respective shafts each support by bushings housed inside said pump housing, wherein a material of which said bushings are made has a thermal expansion coefficient equal, or differing by less than a factor of +/−15%, to the thermal expansion coefficient of a material of which said two gear wheels are made, characterized in that said pump housing includes:
a radially internal portion adapted to face said plurality of teeth of said two gear wheels, said radially internal portion of said pump housing being made of a material with hardness lower than 160 HB, and
a radially outer portion made of a material which has a thermal expansion coefficient equal, or differing by less than a factor of +/−15%, to the thermal expansion coefficient of the material of which said two gear wheels are made.

2. The machine according to claim 1, wherein said bushings and said two gear wheels are made of the same material.

3. The machine according to claim 1, wherein said bushings are made of steel or cast iron.

4. The machine according to claim 1, further comprising a cover and a flange adapted to close axial ends of said pump housing, at least a portion of said bushings being integrated into said cover and/or into said flange.

5. The machine according to claim 1, comprising at least one floating shim plate arranged, along an axial direction, between at least one of said two gear wheels and a respective bushing of said bushings.

6. The machine according to claim 5, wherein said at least one floating shim plate is made of bronze, brass or aluminium alloys.

7. The machine according to claim 1, wherein said bushings include a first pair of bushings adapted to support the shaft of the driving gear wheel on opposing sides thereof, and a second pair of bushings adapted to support the shaft of the driven gear wheel on opposing sides thereof, and wherein at least one first bushing of said first pair of bushings is joined to, or made in one piece with, a first bushing of said second pair of bushings.

8. The machine according to claim 1, wherein said bushings are all separate from each other.

9. The machine according to claim 1, wherein said radially internal portion of said pump housing is made of aluminium or aluminium alloy.

10. The machine according to claim 1, wherein said radially outer portion of said pump housing is made of steel or cast iron.

11. The machine according to claim 1, wherein said radially outer portion of said pump housing is made of a material having a Young's modulus equal to at least double the Young's modulus of the material of which said radially internal portion of said pump housing is made.

12. The machine according to claim 1, wherein said intake opening is positioned in an asymmetrical position with respect to a height of said gear wheels, along an axial extension direction of said two gear wheels.

13. The machine, according to claim 5, comprising a balancing means having surfaces whose area is configured in such a way that the resultant of the forces acting along the axial direction is adapted to keep the floating shim plates on the side opposite the driving gear wheel shaft and the gear wheels pressed against the floating shim plates on the side of the driving gear wheel shaft and to maintain said floating shim plates on the side of the driving gear wheel shaft pressed against the bushings on the side of the driving gear wheel shaft.

14. A machine according to claim 1, wherein said machine is a rotary positive-displacement hydraulic machine with helical rotors in continuous contact wherein said plurality of teeth are meshing teeth without encapsulation and simultaneously defining helical teeth with a face overlap of between 0.75 and 1.1.

15. The machine according to claim 1, wherein said machine is double-contact rotary positive-displacement hydraulic machine.
